(19) United States
(12) Patent Application Publication
(10) Pub. No.: US 2017/0270561 A1
(43) Pub. Date: Sep. 21, 2017

(54) METHOD, TERMINAL AND SERVER FOR MONITORING ADVERTISEMENT EXHIBITION

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Weibo AO, Beijing (CN)

(21) Appl. No.: 15/242,444

(22) Filed: Aug. 19, 2016

Related U.S. Application Data
(63) Continuation of application No. PCT/CN2016/088642, filed on Jul. 5, 2016.

(30) Foreign Application Priority Data
Mar. 21, 2016 (CN) 201610160534X

(51) Int. Cl. G06Q 30/02; H04L 29/08

(52) U.S. Cl. CPC G06Q 30/0242; H04L 67/02; G06Q 30/0277; G06Q 30/0273

(57) ABSTRACT

Disclosed are a method, a terminal and a server for monitoring advertisement exhibition. Wherein, the monitoring method comprises: sending an advertisement exhibition request, which includes the IP address of a terminal device, to an advertisement source server; receiving an application temporary identification for the requested advertisement that is sent by the advertisement source server, wherein the application temporary identification is generated according to the IP address and embodies t information of the region to which the IP address belongs; and sending an advertisement monitoring message, which includes the application temporary identification, to a monitoring server during the exhibition of the requested advertisement.

### CROSS REFERENCE TO RELATED APPLICATIONS

The present application is a continuation of PCT application which has an application number of PCT/CN2016/088642 PCT and was filed on Jul. 5, 2016. This application is based upon and claims priority to Chinese Patent Application No. 201610160534.X, filed on Mar. 21, 2016, the entire contents of which are incorporated herein by reference.

### TECHNICAL FIELD

The present invention relates to the field of Internet technologies, and in particular, to a method, a terminal and a server for monitoring advertisement exhibition.

### BACKGROUND

At present, advertisement operators generally charge advertisers according to exhibition regions and exhibition times. For example, a certain advertiser may purchase 10,000 exhibitions in Beijing region from an advertisement operator, and the advertisement operator may provide advertisement to a user application on a terminal device via an advertisement source server. A monitoring server may be set at the advertisement operator to monitor the launching of the advertisement, for example, the exhibition regions and exhibition times may be counted according to the IP addresses of the terminal devices of users that view the advertisement. A third-party monitoring server that is independent of the advertisement operator may also exist, and the third-party monitoring server may serve the advertiser or the advertisement operator.

FIG. 1 shows a flow chart of a method for monitoring advertisement exhibition in the prior art;

In step S10, a user-side application 1 of a terminal device sends an advertisement exhibition request to an advertisement source server 2. The advertisement source server 2 is generally entrusted to an Internet Data Center (IDC) facilitator, and the advertisement exhibition request is generally an HTTP request.

In step S20, the advertisement source server 2 delivers the advertisement to the user-side application 1.

In step S30, during advertisement exhibition, the user-side application 1 sends an advertisement monitoring message to the monitoring server 3. The advertisement monitoring message is generally an HTTP message.

In step S40, the monitoring server 3 counts the advertisement exhibition requests according to the advertisement monitoring messages. By analyzing the advertisement monitoring message received, the monitoring server 3 may identify the IP address of the sending party, i.e., the terminal device, so that it may be obtained that the requested advertisement is exhibited once by the terminal device with the IP address. The IP address also reflects the information of the region of the terminal device.

However, in the above method of the prior art, the advertisement exhibition request sent by the user-side application 1 to the advertisement source server 2 is transferred via an IDC network maintained by the IDC facilitator, and the dynamic routing resolution of the IDC network may cause that the same advertisement view IP address is wrongly regarded as a plurality of IP addresses, for example, during counting, an IP address that views the advertisement (for example, it belongs to Beijing region) may be wrongly regarded as another IP address (for example, it belongs to Tianjing region). Thus, during the counting of the IP advertisement exhibition at the monitoring server, the advertisement of a certain region (for example, Beijing) will be wrongly counted, so that the counting of advertisement exhibition will be influenced, for example, the income of a certain advertisement operator (for example, in Beijing region) will be reduced. In the above example, the counting of exhibition in Beijing region will be reduced by one.

The principles for the dynamic routing resolution of the IDC network are as follows: the network forwarding of the IDC facilitator is realized by an IDC router, and the IDC facilitator will carry out dynamic flow scheduling according to the flow and adjust the flow forwarding strategy of an egress router of the IDC network, thus when a user requests the same domain name, different ISPs may be assigned, and hence different IP addresses may be assigned, which causes that the information of the region of the click times of the advertisement is wrongly calculated.

### SUMMARY

Therefore, embodiments of the invention intend to improve the monitoring on Internet advertisement exhibition.

According to a first aspect of the embodiments of the invention, there provides a method for monitoring advertisement exhibition. The method includes: receiving an advertisement monitoring message sent by an application on a terminal device during the exhibition of an requested advertisement, wherein the monitoring message includes an application temporary identification, which is generated according to the IP address of the terminal device and embodies the information of the region to which the IP address belongs; and counting the advertisement exhibition according to the application temporary identification.

According to a second aspect of the embodiments of the invention, there provides a server, the server comprises: at least one processor; and a memory communicably connected with the at least one processor for storing instructions executable by the at least one processor, wherein execution of the instructions by the at least one processor causes the at least one processor to: receiving an advertisement monitoring message sent by an application on a terminal device during the exhibition of an requested advertisement, wherein the monitoring message includes an application temporary identification, which is generated according to the IP address of the terminal device and embodies the information of the region to which the IP address belongs; and counting the advertisement exhibition according to the application temporary identification.

According to a third aspect of the embodiments of the invention, there provides a non-transitory computer-readable storage medium storing executable instructions, the executable instructions are set to: receiving an advertisement monitoring message sent by an application on a terminal device during the exhibition of an requested advertisement, wherein the monitoring message includes an application temporary identification, which is generated according to the IP address of the terminal device and embodies the information of the region to which the IP address belongs; and counting the advertisement exhibition according to the application temporary identification.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a flow chart of a method for monitoring advertisement exhibition according to the prior art

FIG. 2 is a flow chart of a method for monitoring advertisement exhibition according to one embodiment of the invention;

FIG. 3 is a flow chart of a method for monitoring advertisement exhibition according to an embodiment of one aspect of the invention;

FIG. 4 is a block diagram of a device for monitoring advertisement exhibition according to an embodiment of one aspect of the invention;

FIG. 5 is a flow chart of a method for monitoring advertisement exhibition according to an embodiment of another aspect of the invention;

FIG. 6 is a block diagram of a device for monitoring advertisement exhibition according to an embodiment of another aspect of the invention;

FIG. 7 is a flow chart of a method for monitoring advertisement exhibition according to an embodiment of yet another aspect of the invention;

FIG. 8 is a block diagram of a device for monitoring advertisement exhibition according to an embodiment of yet another aspect of the invention;

FIG. 9 is a hardware structure diagram of a device for monitoring advertisement exhibition according to the embodiment of the invention.

### DETAILED DESCRIPTION

The technical solutions in the embodiments of the invention will be described clearly and fully below in conjunction with the drawings in the embodiments of the invention. Apparently, the embodiments described are only a part of the embodiments of the invention, rather than being the whole embodiments. All the other embodiments obtained by one of ordinary skills in the art based on the embodiments of the invention without creative work will pertain to the protection scope of the invention.

Referring to FIG. 2, it shows a flow chart of a method for monitoring advertisement exhibition according to one embodiment of the invention.

In step S10, a user-side application 1 of a terminal device sends an advertisement exhibition request, which includes the IP address of a terminal device, to an advertisement source server 2.

In step S12, the advertisement source server 2 identifies the IP address of the sending party from the advertisement exhibition request received, and the sending party is the terminal device.

In step S14, the advertisement source server 2 sends an application temporary identification for the requested advertisement of the user-side application 1 to the user-side application 1, wherein the application temporary identification is generated according to the IP address and embodies information of a region to which the IP address belongs.

In step S20, the advertisement source server 2 delivers the advertisement to the user-side application 1.

In step S30, during advertisement exhibition, the user-side application 1 sends an advertisement monitoring message to the monitoring server 3, wherein the advertisement monitoring message includes the application temporary identification for the requested advertisement of the user-side application 1 In step S40, the monitoring server 3 counts the advertisement exhibition requests according to the advertisement monitoring messages. The counting may be performed by utilizing the application temporary identification included in advertisement monitoring message.

Thus far, the method for monitoring an advertisement shown in FIG. 2 ends. Because the application temporary identification embodies the information of the region, counting error of the monitoring server 3 on the information of the region of advertisement exhibition will not be caused, i.e., the advertisement source server 2 and the monitoring server 3 initiate a dynamic routing resolution strategy on the IDC network.

According to one embodiment of the invention, an advertisement monitoring message sent by an application on a terminal device to a monitoring server includes an application temporary identification that is labelled by an advertisement source server and can embody the IP address of the terminal device identified by the application temporary identification, thereby the monitoring on Internet advertisement exhibition can be improved, and the problem that the information of the region of the click times of the advertisement is wrongly calculated, which is caused by the resolution error of the IP address due to the dynamic routing resolution of the IDC network, may be solved.

In one embodiment, the advertisement exhibition request in step S10 may be an HTTP request. For example, the advertisement source server 2 may acquire the IP address of the user-side terminal device according to the field X-Forwarded-For in the HTTP request sent thereto by the user-side application 1. In additional embodiments, the advertisement exhibition request in step S10 may also be an HTTPS request, a Socket request, or any other suitable request message that may properly indicate that the user-side application 1 requests the advertisement and can identify the IP address of the terminal device therefrom. It should be understood that, in the embodiments of the invention, the implementation mode of the advertisement exhibition request is not limited.

In one embodiment, the application temporary identification generated in step S14 is the IP address itself that is identified in step S12; next, the advertisement source server 2 sends the IP address to the user-side application 1, for example, the IP address is taken as one parameter value in a response message sent to the user-side application 1. The user-side application 1 may resolve the parameter value and buffer the parameter value in the terminal device. For example, if the user-side application 1 is a browser, the parameter value may be stored in a browser buffer.

In another embodiment, the application temporary identification may an encrypted cipher text form of the IP address identified. The monitoring server may obtain the IP address in a plaintext form by decrypting the cipher text of the IP address, so that the information of the region of the terminal device for advertisement exhibition may be obtained.

In yet another embodiment, the application temporary identification may be a two-tuples of the hash value of the IP address identified and the number of the region to which the IP address belongs. For example, the possible regions of Beijing, Tianjing and Shanghai to which the IP address belongs may be numbered as 0, 1 and 2 respectively. In one possible situation, it requires the advertiser that launches an advertisement to only pay attention to the advertisement exhibition in an expected launching region of Beijing, and at this point, the possible regions to which the IP address belongs may be divided into Beijing and other regions, and the region number corresponding thereto may be 0 and 1.

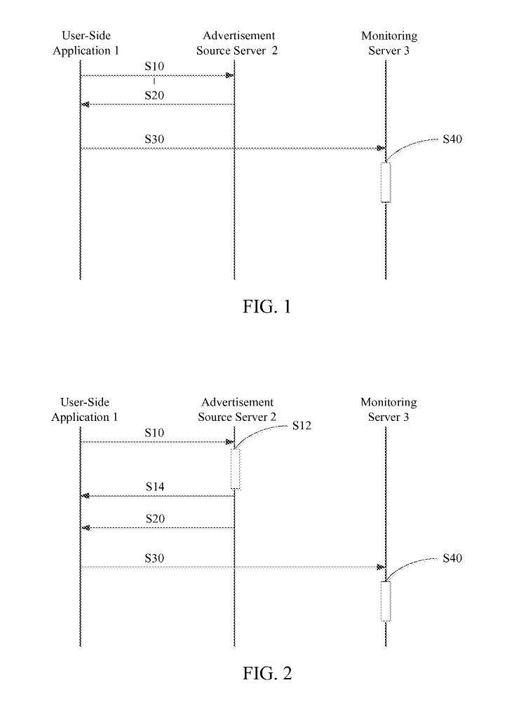

The advertisement monitoring message in step S30 may be an HTTP message, an HTTPS message, a Socket message or any other suitable message that sends the application temporary identification to the user-side application 1. In step S40, as is different from the step S40 shown in FIG. 1 in which advertisement exhibition is counted by utilizing the IP address of the terminal device identified, in the method for monitoring advertisement exhibition shown in FIG. 2, the application temporary identification is utilized to count advertisement exhibition. Therefore, because a certain requested advertisement by the user-side application 1 is labelled by utilizing the application temporary identification and the identification is utilized by the user-side application 1 to count advertisement exhibition, the counting for the IP address of the terminal device in step S10 will not be wrongly regarded as another IP address (i.e., the IP address of the terminal device in step S30), even if, for example, dynamic routing resolution occurs to the IDC network and different IP addresses are assigned to the terminal device that sends the advertisement exhibition request in step S10 and the same terminal device that sends the advertisement monitoring message in step S30. For example, said another IP address may be the IP address of the user-side terminal device acquired in step S40 by the monitoring server 3 according to the field X-Forwarded-For in the HTTP message (advertisement monitoring message) sent thereto by the user-side application 1.

In step S30, the advertisement monitoring message sent by the user-side application 1 to the monitoring server 3 may be an HTTP message, which contains an IP address that functions as the application temporary identification, for example, “123.126.33.253”, then the HTTP message may be, for example:

http://ark.letv.com/t?mid=831192&ip=123_126_33_253.

Optionally, the application temporary identification sent by the advertisement source server 2 to the user-side application 1 in step S14 may be a cipher text form of the IP address of the terminal device, for example, the response message received by the user-side application 1 in step S14 may include a field IP=“aZKPqKRPKPm”, which represents a cipher text form of the IP address “123.126.33.253” of the terminal device returned. In such a case, in step S30, the advertisement monitoring message sent by the user-side application 1 to the monitoring server 3 may be:

http://ark.letv.com/t?mid=831192&ip=aZKPqKRPKPm.

In step S40, furthermore, the monitoring server 3 may identify the IP address of the sending party, i.e., the terminal device from the advertisement monitoring message received, for example, according to the field X-Forwarded-For in the HTTP message sent thereto by the user-side application 1, and generate a reference identification according to the IP address. Next, the reference identification is compared with the application temporary identification included in advertisement monitoring message. It should be understood that, the algorithm for generating the reference identification on the monitoring server 3 is the same as the algorithm for generating the application temporary identification on the advertisement source server 2. In such a case, the monitoring server 3 may also generate two data results when counting the request logs, wherein one data result is the data report before IP address correction (which is acquired by the monitoring server directly) as a reference, and the other data result is the data report after IP address correction (application temporary identification) as the final counting basis. The two data results are saved, for example, for being viewed by the maintenance staff of the IDC facilitator or the advertisement operator to know the running status of the IDC network or the counting difference of advertisement exhibition. Therefore, counting of advertisement exhibition with clear and full basis may be provided to the advertisement operator.

According to the implementation modes of the invention, the user-side application 1 may be various application programs applicable for a desktop computer and a portable computer or various types of APPs applicable for a PAD and an intelligent mobile phone, etc. The monitoring server 3 may be located on the advertisement source server of the advertisement operator or on a third-party that is independent of the advertisement operator.

For step S20, alternatively, after the advertisement source server 2 receives the advertisement exhibition request sent by the user-side application 1, it may also send an advertisement exhibition permission notification and/or an identification of the advertisement to be exhibited to the user-side application 1. The advertisement to be exhibited may be buffered in the terminal device in advance, and/or, the user-side application 1 may access an independent advertisement storage server (for example, a database) and acquire the advertisement to be exhibited by utilizing the advertisement identification obtained. It should be understood that, the embodiments of the invention relate to the monitoring of advertisement exhibition, and the manner in which the advertisement data are delivered is not limited. Similarly, it should be further understood that, in the embodiments of the invention, the type of the advertisement data and the advertisement exhibition mode are not limited, and the advertisement exhibited may be a video, a dynamic picture, a static picture, a text or a combination of one or more thereof.

It should be further understood that, the flow charts shown in the drawings illustrate the functions and operations that may be implemented by the method according to various embodiments of the invention; in some alternative implementations, the order of the method flow may be different from that labelled in the drawings. For example, step S12 and S14 in the drawings may occur after step S20, or may occur concurrently with step S20.

According to one embodiment of the invention, there further discloses a system for monitoring advertisement exhibition. The system includes: a terminal device, which comprises a terminal device application run on the terminal device, wherein the terminal device application is configured for sending an advertisement exhibition request, which includes the IP address of the terminal device, to an advertisement source server and sending an advertisement monitoring message, which includes an application temporary identification, to a monitoring server during the exhibition of the requested advertisement; an advertisement source server, configured for generating the application temporary identification according to the IP address of the terminal device, wherein the application temporary identification embodies the information of the region to which the IP address belongs, and sending the application temporary identification for the requested advertisement to the terminal device application; and a monitoring server, configured for receiving the advertisement monitoring message and counting the advertisement exhibition according to the application temporary identification. It should be understood that, the characteristics illustrated regarding the method for monitoring advertisement exhibition are also applicable to the monitoring system, and it will not be described again here.

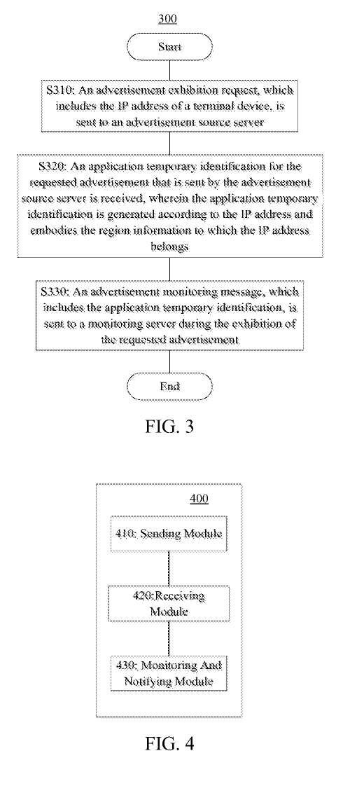

Referring to FIG. 3, it shows a flow chart of a method for monitoring advertisement exhibition 300 according to an embodiment of one aspect of the invention. The method 300 is applicable for being performed on a terminal device.

In step S310, an advertisement exhibition request, which includes the IP address of a terminal device, is sent to an advertisement source server;

In step S320, an application temporary identification for the requested advertisement that is sent by the advertisement source server is received, wherein the application temporary identification is generated according to the IP address and embodies the information of the region to which the IP address belongs; and

In step S330, an advertisement monitoring message, which includes the application temporary identification, is sent to a monitoring server during the exhibition of the requested advertisement.

Referring to FIG. 4, it is a block diagram of a device for monitoring advertisement exhibition 400 according to an embodiment in one aspect of the invention shown in FIG. 3. The device 400 may include: a sending module 410, configured for sending an advertisement exhibition request, which includes the IP address of a terminal device, to an advertisement source server; a receiving module 420, configured for receiving an application temporary identification for the requested advertisement that is sent by the advertisement source server, wherein the application temporary identification is generated according to the IP address and embodies the information of the region to which the IP address belongs; and a monitoring and notifying module 430, configured for sending an advertisement monitoring message to a monitoring server during the exhibition of the requested advertisement, wherein the monitoring message includes the application temporary identification.

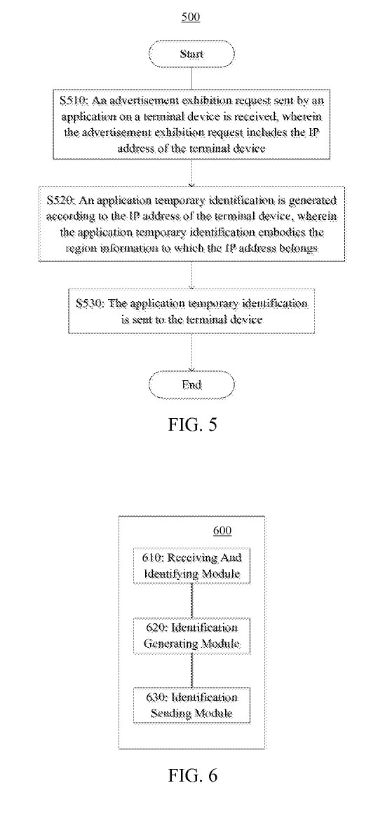

Referring to FIG. 5, it is a flow chart of a method for monitoring advertisement exhibition 500 according to an embodiment of another aspect of the invention. The method 500 is applicable for being performed on an advertisement source server.

In step S510, an advertisement exhibition request sent by an application on a terminal device is received, wherein the advertisement exhibition request includes the IP address of the terminal device;

In step S520, an application temporary identification is generated according to the IP address of the terminal device, wherein the application temporary identification embodies the information of the region to which the IP address belongs; and

In step S530, the application temporary identification is sent to the terminal device.

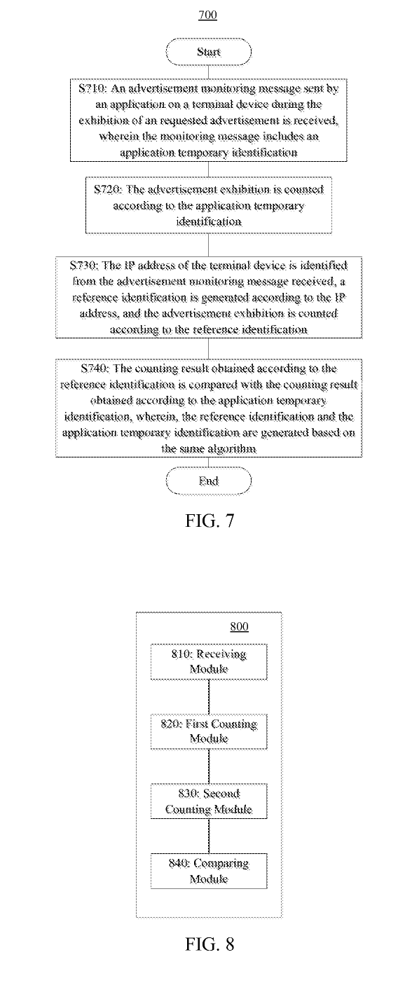

Referring to FIG. 6, it is a block diagram of a device for monitoring advertisement exhibition 600 according to an embodiment in one aspect of the invention shown in FIG. 5. The device 600 may include: a receiving and identifying module 610, configured for receiving an advertisement exhibition request sent by an application on a terminal device, wherein the advertisement exhibition request includes the IP address of the terminal device; an identification generating module 620, configured for generating temporary identification according to the IP address of the terminal device, wherein the application temporary identification embodies the information of the region to which the IP address belongs; and an identification sending module 630, configured for sending the application temporary identification to the terminal device.

Referring to FIG. 7, it is a flow chart of a method for monitoring advertisement exhibition 700 according to an embodiment of yet another aspect of the invention. The method 700 is applicable for being performed on a monitoring server.

In step S710, an advertisement monitoring message sent by an application on a terminal device during the exhibition of an requested advertisement is received, wherein the monitoring message includes an application temporary identification, which is generated according to the IP address of the terminal device and embodies the information of the region to which the IP address belongs; and

In step S720, the advertisement exhibition is counted according to the application temporary identification.

In one embodiment, the method 700 may further include the steps below: in step S730, the IP address of the terminal device is identified from the advertisement monitoring message received, a reference identification is generated according to the IP address, and the advertisement exhibition is counted according to the reference identification; and in step S740, the counting result obtained according to the reference identification is compared with the counting result obtained according to the application temporary identification, wherein, the reference identification and the application temporary identification are generated based on the same algorithm.

Referring to FIG. 8, it is a block diagram of a device for monitoring advertisement exhibition 800 according to an embodiment in one aspect of the invention shown in FIG. 7. The device 800 may include: a receiving module 810, configured for receiving an advertisement monitoring message sent by an application on a terminal device during the exhibition of an requested advertisement, wherein the monitoring message includes an application temporary identification, which is generated according to the IP address of the terminal device and embodies the information of the region to which the IP address belongs; and a first counting module 820, configured for counting the advertisement exhibition according to the application temporary identification.

In one embodiment, the device 800 may further include: a second counting module 830, configured for identifying the IP address of the terminal device from the advertisement monitoring message received, generating a reference identification according to the IP address, and counting the advertisement exhibition according to the reference identification; and a comparing module 840, configured for comparing the counting result obtained by the second counting module with the counting result obtained by the first counting module, wherein, the reference identification and the application temporary identification are generated based on the same algorithm.

According to the implementation modes of the invention, an advertisement monitoring message sent by an application on a terminal device to a monitoring server includes an application temporary identification that is labelled by an advertisement source server and can embody the IP address of the terminal device identified by the application temporary identification, so that the problem that the information of the region of the click times of the advertisement is wrongly calculated, which is caused by the resolution error of the IP address due to the dynamic routing resolution of the IDC network, may be reduced. Thereby, the advertisement income of the advertisement operator may be guaranteed.

An embodiment of the present disclosure further provides a non-transitory computer-readable storage medium storing executable instructions, which can be executed by an electronic device to perform any methods for detecting a monitoring of advertisement exhibition mentioned by embodiments of the present disclosure.

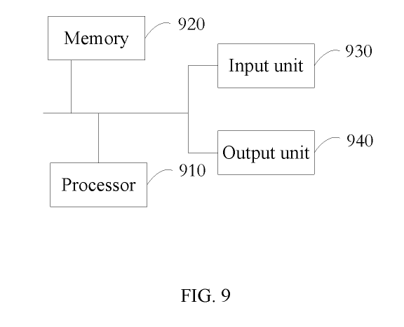

FIG. 9 is a hardware structure diagram of a device for monitoring advertisement exhibition according to an embodiment of the present disclosure. As shown in FIG. 9, the device includes: one or more processors 910 and memory 920. A processor 910 is showed in FIG. 9 for an example. The device of monitoring advertisement exhibition can be either a server or a terminal.

The device which is configured to perform the methods for detecting a monitoring of advertisement exhibition can also include: input unit 930 and output unit 940.

Processor 910, memory 920, input unit 930 and output unit 940 can be connected by BUS or other methods, and BUS connecting is showed in FIG. 9 for an example.

Memory 920 can be used for storing non-transitory software program, non-transitory computer executable program and modules as a non-transitory computer-readable storage medium, such as corresponding program instructions/modules for the methods for live streaming mentioned by embodiments of the present disclosure (such as shown in FIG. 4, the sending module 410, the receiving module 420, the monitoring and notifying module 430, or shown in FIG. 6, the receiving and identifying module 610, the identification generating module 620 and the identification sending module 630 and the like, or shown in FIG. 8, the receiving module 810 and the first counting module 820 and the like). Processor 910 performs kinds of functions and detecting a monitoring of advertisement exhibition of the device by executing non-transitory software program, instructions and modules which are stored in memory 920, thereby realizes the methods for detecting a monitoring of advertisement exhibition by embodiments of the present disclosure.

Memory 920 can include program storage area and data storage area, thereby the operating system and applications required by at least one function can be stored in program storage area and data created by using the device for live streaming can be stored in data storage area. Furthermore, memory 920 can include high speed Random-access memory (RAM) or non-volatile memory such as magnetic disk storage device, flash memory device or other non-volatile solid state storage devices. In some embodiments, memory 920 can include long-distance setup memories relative to processor 910, which can communicate with the device for monitoring advertisement exhibition by networks. The examples of said networks are including but not limited to Internet, Intranet, LAN, mobile Internet and their combinations.

Input unit 930 can be used to receive inputted number, character information and key signals causing user configures and function controls of the device for monitoring advertisement exhibition. Output unit 940 can include a display screen or a display device.

The said module or modules are stored in memory 920 and perform the methods for detecting a monitoring of advertisement exhibition when executed by one or more processors 910.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-15. (canceled)

16. A method for monitoring advertisement exhibition, which is applied to the server, the method comprising:
receiving an advertisement monitoring message sent by an application on a terminal device during the exhibition of an requested advertisement, wherein the monitoring message includes an application temporary identification which is generated according to the IP address of the terminal device and embodies the information of a region to which the IP address belongs; and
counting the advertisement exhibition according to the application temporary identification.

17. The method according to claim 16, wherein the application temporary identification is one of an IP address, the cipher text form of an IP address, and a two-tuples of the hash value of an IP address and the number of the region to which the IP address belongs.

18. The method according to claim 16, further comprising:
identifying the IP address of the terminal device from the received advertisement monitoring message, generating a reference identification according to the IP address, and counting the advertisement exhibition according to the reference identification; and comparing the counting result obtained according to the reference identification with the counting result obtained according to the application temporary identification; wherein, the reference identification and the application temporary identification are generated based on the same algorithm.

19. A server, comprising:
at least one processor; and
a memory communicably connected with the at least one processor for storing instructions executable by the at least one processor, wherein execution of the instructions by the at least one processor causes the at least one processor to:
receiving an advertisement monitoring message sent by an application on a terminal device during the exhibition of an requested advertisement, wherein the monitoring message includes an application temporary identification, which is generated according to the IP address of the terminal device and embodies the information of a region to which the IP address belongs; and counting the advertisement exhibition according to the application temporary identification.

20. The server according to claim 19, wherein the application temporary identification is one of an IP address, the cipher text form of an IP address, and a two-tuples of the hash value of an IP address and the number of the region to which the IP address belongs.

21. The server according to claim 19, wherein the server also:
identifying the IP address of the terminal device from the advertisement monitoring message received, generating a reference identification according to the IP address, and counting the advertisement exhibition according to the reference identification; and
comparing the counting result of counting the advertisement exhibition according to the reference identification with the counting result of counting the advertisement exhibition according to the application temporary identification;
wherein the reference identification and the application temporary identification are generated based on the same algorithm.

22. A non-transitory computer-readable storage medium storing executable instructions, the executable instructions are programmed to:
receiving an advertisement monitoring message sent by an application on a terminal device during the exhibition of an requested advertisement, wherein the monitoring message includes an application temporary identification, which is generated according to the IP address of the terminal device and embodies the information of the region to which the IP address belongs; and
counting the advertisement exhibition according to the application temporary identification.

23. The non-transitory computer-readable storage according to claim 22, wherein the application temporary identification is one of an IP address, the cipher text form of an IP address, and a two-tuples of the hash value of an IP address and the number of the region to which the IP address belongs.

24. The non-transitory computer-readable storage according to claim 22, wherein the executable instructions are set to:
identifying the IP address of the terminal device from the advertisement monitoring message received, generating a reference identification according to the IP address, and counting the advertisement exhibition according to the reference identification; and
comparing the counting result obtained according to the reference identification with the counting result obtained according to the application temporary identification;
wherein the reference identification and the application temporary identification are generated based on the same algorithm.
